(19) United States
(12) Patent Application Publication
(10) Pub. No.: US 2008/0034265 A1
(43) Pub. Date: Feb. 7, 2008

(54) Tester For Testing Semiconductor Device

(75) Inventor: Jong Koo KANG, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Unitest Inc., Yongin-si (KR)

(21) Appl. No.: 11/828,004

(22) Filed: Jul. 25, 2007

(30) Foreign Application Priority Data
Aug. 1, 2006 (KR) 10-2006-0072746

(51) Int. Cl. G06F 11/25; G06F 11/263; G06F 11/277

(52) U.S. Cl. 714/736; 714/738; 714/E11.177; 714/E11.155; 714/E11.175

(57) ABSTRACT

A tester for testing a semiconductor device is disclosed. In accordance with the tester, a data is fetched using a data strobe signal transmitted from a DUT, thereby increasing an accuracy of the fetched data, securing a window for fetching a last portion of the data using a data strobe enable signal and efficiently compensating for a round trip delay of an expected data without using the deskew component.

### FIELD OF THE INVENTION

The present invention relates to a tester for testing a semiconductor device, and in particular to a tester for testing a semiconductor device wherein a data is fetched using a data strobe signal transmitted from a DUT, thereby increasing an accuracy of the fetched data, securing a window for fetching a last portion of the data using a data strobe enable signal and efficiently compensating for a round trip delay of an expected data without using the deskew component.

### DESCRIPTION OF PRIOR ART

A tester for testing a semiconductor device tests whether the semiconductor device is defective. The tester for testing the semiconductor device is designed and developed according to a development state of a memory device, a DRAM in particular which takes up most of the memory devices since the tester for testing the semiconductor device is mostly used for testing the memory devices.

The development of the DRAM is progressing from an EDO (Extended Data Output) DRAM, SDRAM (Synchronous DRAM), Rambus DRAM to DDR (Double Data Rate) DRAM.

In order to test the DRAM, a high speed and a high accuracy are required for the tester so as to correspond to a high speed DRAM. In addition, as a capacity of the memory is increased, a time required for testing the DRAM also increases. Therefore, a testing speed is also required to be increased. Moreover, a cost for testing the memory should be reduced by embodying a miniaturized and economical tester.

Of the tester for testing the semiconductor device, the memory tester in particular is typically used for testing and verifying a memory component or a memory module in a form of a SIMM or DIMM. The tester detects a functional defect of the memory module or the memory component prior to an installation thereof in a real computer system.

The tester is classified into a hardware semiconductor device tester and a software diagnostic program executed in a PC environment. However, since the software diagnostic program diagnoses a state of the memory when the memory module or the memory component is installed in the real computer, the hardware semiconductor device tester is mainly used during a semiconductor memory manufacturing process.

The tester may be classified as a high-end tester referred to as an ATE (Automatic Test Equipment), a medium range memory tester and a low-end memory tester.

The ATE which is the high-end tester is typically used in order to carry out a test process of the memory device. The conventional ATE carries out tests such as a DC test for testing whether a DC parameter is suitable for a digital operation of a circuit, a transmission delay time of signals, and an AC margin related to a set-up time and a hold time. The ATE also generates a test pattern and a timing for the test. However, a manufacturing cost of the ATE is high since the ATE is manufactured using a dedicated equipment such as a main frame having a large size and a high price.

FIG. 1 is a block diagram illustrating a conventional tester for testing a semiconductor device.

As shown in FIG. 1, the conventional tester comprises a pattern generator 110, a timing generator 120, a format controller 130, a driver 140, an output comparator 150, and a test result storage 160. In addition to these components, the conventional tester may comprise a power supply controller for the DC test, a component for generating a clock signal, a component for supplying a power for an operation of a DUT (Device Under Test) 180, a component for relaying a test pattern data to the DUT 180 and receiving a test result from the DUT 180, a component for receiving a test pattern program from an outside, and a component for transmitting the test result to the outside. However, a description thereof is omitted.

The pattern generator 110 generates the test pattern data required for testing the DUT 180 based on the test pattern program. For instance, the test pattern program is written to include an instruction for carrying out various operations in order to carry out the test. The pattern generator 110 generates the test pattern data by receiving and interpreting the test pattern program from an external storage for instance. The test pattern data includes a data such as a command, address and a data inputted to the DUT 180. In addition, an expected data corresponding to the generated test pattern data is generated.

The timing generator 120 generates a timing edge which is a reference for converting the test pattern data generated in the pattern generator 110 into various waveforms. The timing edge is generated using a plurality of clocks for a smooth conversion.

The format controller 130 converts the test pattern data to a desired waveform based on the timing edge.

The driver 140 transmits the converted test waveform to the DUT 180.

The comparator 150 tests the DUT 180 by comparing the test output data being outputted from the DUT 180 after an operation of the DUT 180 is complete by the test waveform applied to the DUT 180 with the expected data generated in the pattern generator 110.

The test result storage 160 stores a test result based on a result of the comparison of the comparator 150. For instance, an information on a defective DUT is stored.

A conventional method for fetching the data from the DUT 180, i.e. fetching the test output data from the DUT 180 in the conventional ATE is carried out by generating a predetermined strobe signal in the ATE and fetching the test output data at a time corresponding to the predetermined strobe signal.

In accordance with the conventional method, a possibility of an error is increased as an operating speed of the semiconductor device increases. This is because the data being outputted from the DUT 180 is minutely shifted with respect to the predetermined strobe signal. Therefore, the conventional method for fetching the data is disadvantageous in that the data being outputted from a DDR memory cannot be fetched accurately.

In case of testing the semiconductor device of a source synchronous type using a data strobe signal DQS representing an effective period of a data signal DQ transmitted from a source, i.e. the DUT 180, a multi-strobe method may be used for fetching the data. In accordance with the multi-strobe method, the tester generates a plurality of the strobe signals at a predetermined point of time to determine an edge of the data strobe signal DQS for fetching the data. However, the multi-strobe method requires a highly priced ASIC component in order to generate and process the plurality of the strobe signals. Therefore, the multi-strobe method increases a cost of the tester and has a high error rate in fetching data.

Moreover, a data synchronization in a synchronous system is difficult due to a round trip delay. The round trip delay refers to a delay time taken while a signal arrives at its destination and returns back.

For instance, when the comparator 150 compares the test output data to the expected data by reading the test output data from the DUT 180, a difference in the round trip delay generated due to a difference in the path, i.e. a difference in a time taken by a control command ‘READ’ for reading the test output data generated in the pattern generator 110 from leaving the pattern generator 110 until arriving at the DUT 180, and a time taken by the test output data from leaving the DUT 180 to correspond to the control command ‘READ’ until arriving at the comparator 150, and a time taken by the expected data from leaving the pattern generator 110 to arriving at the comparator 150. A conventional method for synchronizing the test output data and the expected data by compensating for the round trip delay wherein the expected data is delayed by the difference in the round trip delay so that the test output data and the expected data reaches the comparator 150 at the same time is widely used.

However, because a deskew element for delaying the test output data for each of the channels of the DUT 180 by the round trip delay generated due to the DUT 180 should be used, the conventional method is not efficient. Moreover, when the round trip delay of a large scale occurs, the deskew element cannot compensate for the round trip delay.

### SUMMARY OF THE INVENTION

It is an object of the present invention to provide a tester for testing a semiconductor device wherein a data is fetched using a data strobe signal transmitted from a DUT, thereby increasing an accuracy of the fetched data, securing a window for fetching a last portion of the data using a data strobe enable signal and efficiently compensating for a round trip delay of an expected data without using the deskew component.

In order to achieve the above-described objects of the present invention, there is provided a tester for testing a DUT, the tester comprising: a pattern generator for generating a test pattern data for a test of the DUT and an expected data based on a test pattern program; a pattern data transmitter for transmitting the test pattern data to the DUT; a output data receiver for receiving an output data and a data strobe signal from the DUT corresponding to the test pattern data transmitted to the DUT; a data fetcher for generating a fetch reference clock based on the data strobe signal received from the DUT and fetching the output data based on the fetch reference clock; and a test comparator for comparing a test output data obtained by converting the output data with the expected data to determine the DUT is a defective DUT.

It is preferable that the tester in accordance with the present invention further comprises: a re-synchronizer for re-synchronizing the output data fetched by the data fetcher based on an internal clock of the tester and outputting the re-synchronized output data as the test output data; and a data round trip delay compensator for compensating the expected data according to the round trip delay, wherein the expected data compensated by the round trip delay compensator and the test output data being outputted from the re-synchronizer are compared.

Preferably, the pattern generator generates a data strobe enable signal to be transmitted to the data fetcher, the data strobe enable signal enabling the data strobe signal, and the data fetcher removes a postamble of the data strobe signal based on the data strobe enable signal and generates the fetch reference clock based on the data strobe signal being removed of the postamble.

It is preferable that the tester in accordance with the present invention further comprises a deskew controller for compensating a timing skew generated in each of channels of the DUT prior to transmitting the test pattern data to the DUT; and a driver for converting the test pattern data having the timing skew thereof compensated in a manner that the converted test pattern data has one of levels ‘high’, ‘low’ and ‘termination’ wherein the driver transmits the converted test pattern data to the DUT.

Preferably, the output data receiver comprises: an output comparator for comparing each of the output data from the DUT and the data strobe signal with a predetermined threshold value; and a reception deskew controller for compensating for a timing skew generated in each of channels of the DUT for the output data and the data strobe signal being outputted from the output comparator.

It is preferable that the data fetcher de-serializes the output data based on the fetch reference clock.

Preferably, the pattern generator generates a compare enable signal for enabling the comparison of the test comparator and transmits the compare enable signal to each of the re-synchronizer and the data round trip delay compensator, wherein the re-synchronizer re-synchronizes the output data fetched by the data fetcher based on the compare enable signal and the internal clock, the resynchronized data being output as the test output data, wherein the data round trip delay compensator compensates the compare enable signal to correspond to the round trip delay, and wherein the test comparator carries out the comparison only when the compare enable signal in the re-synchronizer or the compare enable signal compensated by the data round trip delay compensator is enabled.

It is preferable that the re-synchronizer or the data round trip delay compensator comprises a dual clock FIFO, the dual clock FIFO dividing and utilizing a clock being a reference of a write operation and a clock being a reference of a read operation.

Preferably, the tester in accordance with the present invention further comprises a fetch clock round trip delay compensator for compensating for the round trip delay of the data strobe enable signal, the internal clock or the compare enable signal transmitted to the re-synchronizer.

It is preferable that the tester in accordance with the present invention further comprises a reference clock selector for selecting the fetch reference clock from the data strobe signal or the internal clock of the tester, and wherein the data fetcher fetched the output data from the DUT based on the fetch reference clock selected by the reference clock selector.

Preferably, the pattern generator generates a data strobe enable signal to be transmitted to the data fetcher, the data strobe enable signal enabling the data strobe signal, and the reference clock selector selects the fetch reference clock from a signal having a postamble removed thereof and the internal clock based on the data strobe enable signal.

It is preferable that further comprising a fetch clock round trip delay compensator for compensating for a round trip delay of the data strobe enable signal or the internal clock.

### BRIEF DESCRIPTION OF THE DRAWINGS

FIG. 1 is a block diagram illustrating a conventional tester for testing a semiconductor device.

FIG. 2 is a diagram illustrating a preferred embodiment of a tester for testing a semiconductor device in accordance with the present invention.

FIG. 3 is a diagram illustrating another preferred embodiment of a tester for testing a semiconductor device in accordance with the present invention.

FIG. 4 is a diagram illustrating an actual embodiment of a tester for testing a semiconductor device in accordance with the present invention.

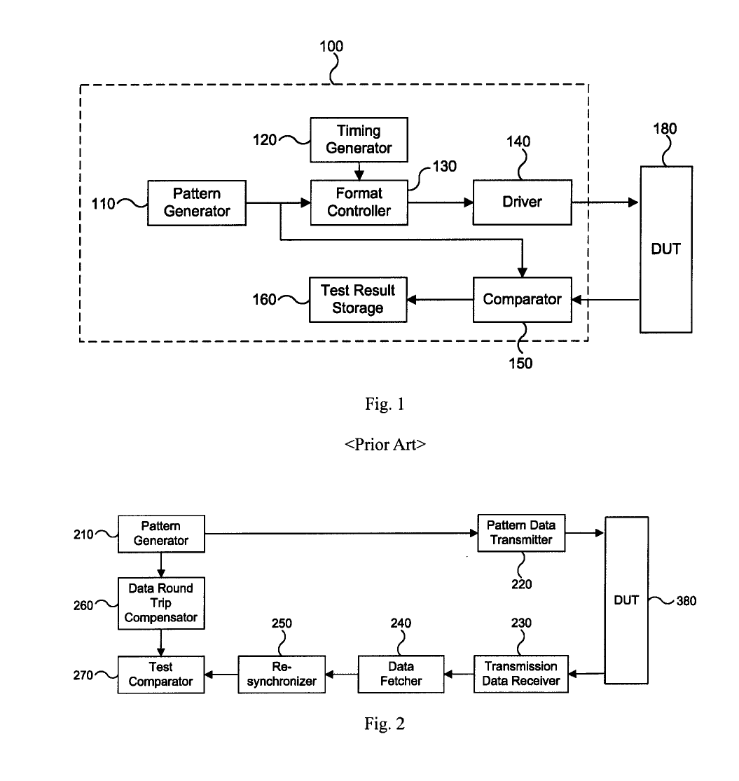

### DETAILED DESCRIPTION OF THE PREFERRED EMBODIMENTS

The present invention will now be described in detail with reference to the accompanied drawings.

FIG. 2 is a diagram illustrating a preferred embodiment of a tester for testing a semiconductor device in accordance with the present invention.

Referring to FIG. 2, the tester comprises a pattern generator 210, a pattern data transmitter 220, an output data receiver 230, a data fetcher 240, a re-synchronizer 250, a data round trip delay compensator 260, a test comparator 270 and a fetch clock round trip delay compensator 290 (shown in FIG. 4).

In addition, when embodied, the tester may include components for distributing the test pattern data from the output data receiver 230 to a plurality of DUTs and receiving output data from the plurality of DUTs simultaneously. However, a detailed description thereof is omitted.

The pattern generator 210 generates the test pattern data including a command, an address and a data signal required for a test of a DUT 380 and an expected data corresponding to the test pattern data based on a test pattern program.

In addition, while the tester may further comprise a configuration for carrying out a conversion of the test pattern data for each of channels of the DUT 380, a detailed description thereof is omitted because the configuration is not directly related to a key feature of the present invention.

The pattern data transmitter 220 transmits the test pattern data generated by the pattern generator 210 to the DUT 380. A timing skew generated in the channels of the DUT 380 during the transmission of the test pattern data may differ for each of the channels. That is, because a signal transmission environment is not same for each of the channels, the timing skew is generated. Therefore, the pattern data transmitter 220 may comprises a transmission deskew controller 223 (shown in FIG. 4) for compensating the timing skew generated in each of the channels of the DUT 380 prior to transmitting the test pattern data to the DUT 380.

In addition, the pattern data transmitter 220 may comprise a driver 226 (shown in FIG. 4) for converting the test pattern data having the timing skew thereof compensated to be applied to the DUT 380 in a manner that the converted test pattern data has one of levels ‘high’, ‘low’ and ‘termination’. That is, when a reflective component is to be removed during applying the test pattern data to the DUT 380 by the driver 226, the level ‘termination’ is selected. In other case, the level ‘high’ or ‘low’ is selected.

The output data receiver 230 receives an output data and a data strobe signal from the DUT 380 corresponding to the test pattern data transmitted to the DUT 380.

The output data receiver 230 may include the output comparator 233 (shown in FIG. 4) in order to carry out a comparison of a voltage level of the output data or the data strobe signal with a predetermined threshold value. That is, when the voltage level of the output data or the data strobe signal is higher than the threshold value, the output data or the data strobe signal is determined to have the level ‘high’. When the voltage level of the output data or the data strobe signal is lower than the threshold value, the output data or the data strobe signal is determined to have the level ‘low’

In addition, the output data receiver 230 may also include the reception deskew controller 236 (shown in FIG. 4) in order to compensate for the timing skew generated in each of the channels of the DUT 380.

The data fetcher 240 generates a fetch reference clock based on the data strobe signal received from the DUT 380 and then fetches the output data based on the fetch reference clock. The data strobe signal is generated synchronized to the output data in the DUT 380.

When the output data is fetched by the data fetcher 240 using the data strobe signal, a window for fetching a last portion of the output data is narrowed. That is, the data strobe signal is invalidated at a moment the output data is invalidated so that a postamble is added to the data strobe signal. Therefore, the window for fetching the last portion of the output data is narrowed.

In order to prevent the narrowing of the window, the pattern generator 210 may generate a data strobe enable signal for enabling the data strobe signal and then may transmit the data strobe enable signal to the data fetcher 240. The pattern generator 210 predicts a point of time at which the data strobe signal is generated by the DUT 380 to generate the data strobe enable signal. In such case, the data fetcher 240 may remove the postamble of the data strobe signal based on the data strobe enable signal. After the postamble is removed and the data fetcher 240 generates the fetch reference clock, the window for fetching the last portion of the output data may have size same as a size of a window for fetching other portion of the output data.

During the generation by the pattern generator 210 and the transmission to the data fetcher 240 of the data strobe enable signal, a round trip delay generated in each of the channels of the DUT 380 may be considered. That is, while a command for outputting the output data is generated in the pattern generator 210 and transmitted to the DUT 380, and the data strobe signal is transmitted from the DUT 380 to the data fetcher 240, the data strobe enable signal is transmitted from the pattern generator 210 to the data fetcher 240 directly. Therefore, a difference of the round trip delay occurs.

Accordingly, the tester for testing the semiconductor device in accordance with the present invention may further comprise the fetch clock round trip delay compensator 290 (shown in FIG. 4) for compensating for the difference of the round trip delay between the data strobe signal and the data strobe enable signal.

That is, when the data strobe signal is transmitted and received using the transmission deskew controller 223 (shown in FIG. 4) and the reception deskew controller 236 (also shown in FIG. 4), the tester in accordance with the present invention may further comprise the fetch clock round trip delay compensator 290.

In addition, the data fetcher 240 de-serializes the output data based on the fetch reference clock. That is, the data fetcher 240 de-serializes the test pattern data being outputted from the DUT 380 operating at a high speed in order to utilize the output data in the tester operating at a relatively low speed.

The re-synchronizer 250 re-synchronizes the output data fetched by the data fetcher 240 based on an internal clock of the tester and outputs the re-synchronized output data as the test output data. That is, after the data fetcher 240 fetches the output data from the DUT 380 based on the data strobe signal using the fetch reference clock, the re-synchronizer 250 synchronizes the fetched output data to the internal clock of the tester.

The data round trip delay compensator 260 compensates the expected data according to the round trip delay. That is, the data round trip delay compensator 260 delays the expected data by the round trip delay of the test output data.

The delay of the expected data may be carried out by a conventional deskew component. However, because the round trip delay may be larger than a delay of each of the channels and should be compensated for a plurality of the expected data when the conventional deskew component is used for the expected data, a highly priced deskew component is required. Therefore, the present invention employs a FIFO component instead of the deskew component to easily compensate for the round trip delay of the test output data.

The test comparator 270 compares the test output data compensated by the data round trip delay compensator 260 with the expected data to determine whether the DUT 380 is a defective DUT.

The re-synchronizer 250, the data round trip delay compensator 260 and the test comparator 270 may be configured to operate when the compare enable signal is enabled.

That is, the pattern generator 210 generates a compare enable signal for enabling the comparison of the test comparator 270 and transmits the compare enable signal to each of the re-synchronizer 250 and the data round trip delay compensator 260.

The compare enable signal received by the re-synchronizer 250 requires the compensation for the difference in the round trip delay similar to the internal clock. The fetch clock round trip delay compensator 290 may compensate the compare enable signal received by the re-synchronizer 250 for the difference in the round trip delay.

Similarly, the data round trip delay compensator 260 may compensate for the difference in the round trip delay of the compare enable signal.

When the difference in the round trip delay is compensated for, the test comparator 270 may carry out the comparison only when the compare enable signal in the re-synchronizer 250 or the compare enable signal compensated by the data round trip delay compensator 260 is enabled.

In addition, the re-synchronizer 250 or the data round trip delay compensator 260 may be embodied using a dual clock FIFO that divides and utilizes a clock which is a reference of a write operation and a clock which is a reference of a read operation. That is, the re-synchronizer 250 or the data round trip delay compensator 260 may be configured to carry out a write operation for the re-synchronization or the compensation only when the compare enable signal is enabled.

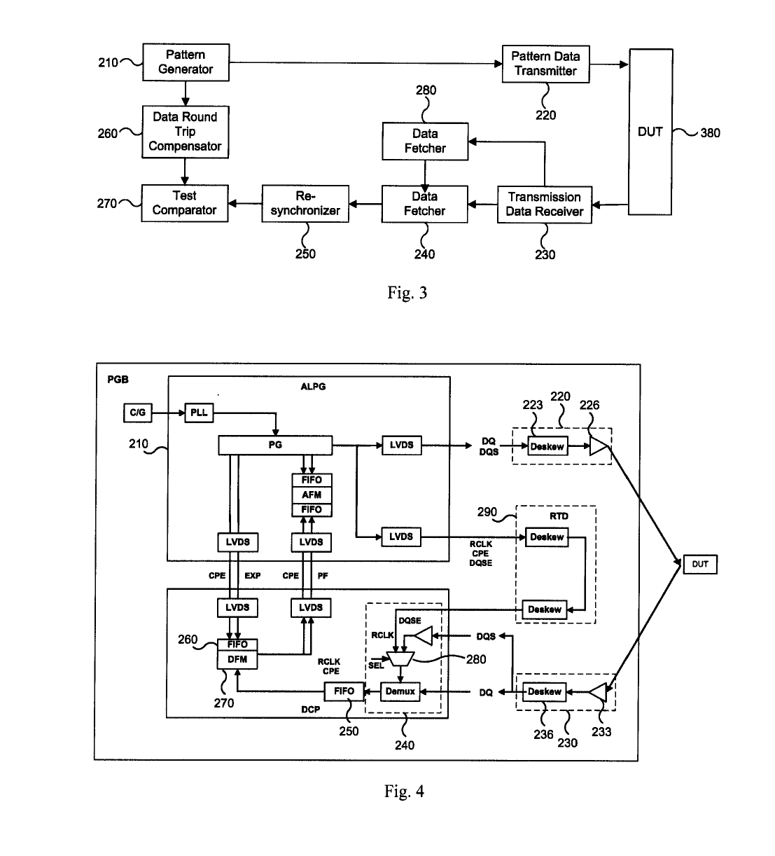

The tester in accordance with the present invention shown in FIG. 2 fetches the output data of the DUT 380 using the data strobe signal as the fetch reference clock. However, the output data may be fetched using the internal clock of the tester as the fetch reference clock instead of the data strobe signal. An embodiment wherein one of the data strobe signal and the internal clock is selected to be used as the fetch reference clock is described with reference to FIG. 3 below.

FIG. 3 is a diagram illustrating another preferred embodiment of the tester for testing the semiconductor device in accordance with the present invention.

Referring to FIG. 3, the tester comprises the pattern generator 210, the pattern data transmitter 220, the output data receiver 230, the data fetcher 240, the re-synchronizer 250, the data round trip delay compensator 260, the test comparator 270, a reference clock selector 280 and the fetch clock round trip delay compensator 290 (shown in FIG. 4). The tester shown in FIG. 3 differs from that of FIG. 2 in that the fetch reference clock which is a reference when fetching the output data may be selected. Therefore, a description of the tester shown in FIG. 3 is focused on the reference clock selector 280.

The reference clock selector 280 selects the fetch reference clock for fetching the output data from the data strobe signal or the internal clock of the tester.

The selected fetch reference clock is provided so as to fetch a data transmitted from the data fetcher 240 to the DUT 380.

Similar to the tester shown in FIG. 2, the pattern generator 210 may generate the data strobe enable signal for enabling the data strobe signal, and may transmit the data strobe enable signal to the reference clock selector 280 when the data strobe enable signal is transmitted to the reference clock selector 280, the reference clock selector 280 may select the fetch reference clock based on an internal selection signal. That is, when the internal selection signal is set to use the data strobe signal, the data is fetched based on the data strobe signal, and when the internal selection signal is set to use the internal clock of the tester, the data is fetched based on the internal clock.

In addition, when the data strobe signal is used as the fetch reference clock, the postamble of the data strobe signal may be removed based on the data strobe enable signal, and the reference clock selector 280 may select one of the data strobe signal having the postamble thereof removed and the internal clock as the fetch reference clock.

FIG. 4 is a diagram illustrating an actual embodiment of the tester for testing the semiconductor device in accordance with the present invention.

Referring to FIG. 4, the test pattern data generated the pattern generator 210, DQ and DQS for instance, is transmitted to the DUT 380 through the transmission deskew controller 223 and the driver 226.

In addition, the internal clock RCLK, the compare enable signal CPE and the data strobe enable signal DQSE are transmitted from the pattern generator 210 to the reference clock selector 280 through the fetch clock round trip delay compensator 290. The reference clock selector 280 selects one of the data strobe signal DQS from the DUT 380 having the postamble thereof removed by the data strobe enable signal DQSE and the internal clock RCLK as the fetch reference clock based on the selection signal SEL.

On the other hand, the output data DQ and the data strobe signal DQS from the DUT 380 are transmitted to the data fetcher 240 through the output comparator 233 and the reception deskew controller 236.

The output data DQ is re-synchronized by the re-synchronizer 250 after being fetched. The output data DQ is re-synchroinized by the internal clock RCLK and the compare enable signal CPE.

The pattern generator 210 transmits the compare enable signal CPE and the expected data EXP to the data round trip delay compensator 260, and the test comparator 270 compares the expected data having the round trip delay thereof compensated with the re-synchronized test output data. A data information and an address information of in a result of the comparison are stored in DFM (Data Fail Memory) and an AFM (Address Fail Memory), respectively.

While the actual embodiment of the tester shown in FIG. 4 in accordance with the present invention is embodied based on the tester in accordance with the present invention shown in FIG. 3, an actual embodiment of the tester shown in FIG. 2 may be embodied similarly except the reference clock selector 280. Therefore, a detailed description thereof is omitted.

While the present invention has been particularly shown and described with reference to the preferred embodiment thereof, it will be understood by those skilled in the art that various changes in form and details may be effected therein without departing from the spirit and scope of the invention.

As described above, in accordance with the tester for testing the semiconductor device of the present invention, the data is fetched using the data strobe signal transmitted from the DUT, thereby increasing an accuracy of the fetched data. Moreover, the window for fetching the last portion of the data is secured using the data strobe enable signal and the round trip delay of the expected data is efficiently compensated without using the deskew component.

1. A tester for testing a DUT, the tester comprising:
a pattern generator for generating a test pattern data for a test of the DUT and an expected data based on a test pattern program;
a pattern data transmitter for transmitting the test pattern data to the DUT;
a output data receiver for receiving an output data and a data strobe signal from the DUT corresponding to the test pattern data transmitted to the DUT;
a data fetcher for generating a fetch reference clock based on the data strobe signal received from the DUT and fetching the output data based on the fetch reference clock; and
a test comparator for comparing a test output data obtained by converting the output data with the expected data to determine the DUT is a defective DUT.

2. The tester in accordance with claim 1, further comprising:
a re-synchronizer for re-synchronizing the output data fetched by the data fetcher based on an internal clock of the tester and outputting the re-synchronized output data as the test output data; and
a data round trip delay compensator for compensating the expected data according to the round trip delay,
wherein the expected data compensated by the round trip delay compensator and the test output data being outputted from the re-synchronizer are compared.

3. The tester in accordance with claim 1, wherein the pattern generator generates a data strobe enable signal to be transmitted to the data fetcher, the data strobe enable signal enabling the data strobe signal, and the data fetcher removes a postamble of the data strobe signal based on the data strobe enable signal and generates the fetch reference clock based on the data strobe signal being removed of the postamble.

4. The tester in accordance with claim 1, wherein the pattern data transmitter comprises a deskew controller for compensating a timing skew generated in each of channels of the DUT prior to transmitting the test pattern data to the DUT; and
a driver for converting the test pattern data having the timing skew thereof compensated in a manner that the converted test pattern data has one of levels ‘high’, ‘low’ and ‘termination’ wherein the driver transmits the converted test pattern data to the DUT.

5. The tester in accordance with claim 1, wherein the output data receiver comprises:
an output comparator for comparing each of the output data from the DUT and the data strobe signal with a predetermined threshold value; and
a reception deskew controller for compensating for a timing skew generated in each of channels of the DUT for the output data and the data strobe signal being outputted from the output comparator.

6. The tester in accordance with claim 1, wherein the data fetcher de-serializes the output data based on the fetch reference clock.

7. The tester in accordance with claim 2, wherein the pattern generator generates a compare enable signal for enabling the comparison of the test comparator and transmits the compare enable signal to each of the re-synchronizer and the data round trip delay compensator,
wherein the re-synchronizer re-synchronizes the output data fetched by the data fetcher based on the compare enable signal and the internal clock, the resynchronized data being output as the test output data,
wherein the data round trip delay compensator compensates the compare enable signal to correspond to the round trip delay, and
wherein the test comparator carries out the comparison only when the compare enable signal in the re-synchronizer or the compare enable signal compensated by the data round trip delay compensator is enabled.

8. The tester in accordance with claim 7, wherein the re-synchronizer or the data round trip delay compensator comprises a dual clock FIFO, the dual clock FIFO dividing and utilizing a clock being a reference of a write operation and a clock being a reference of a read operation.

9. The tester in accordance with claim 2, further comprising a fetch clock round trip delay compensator for compensating for the round trip delay of a data strobe enable signal, the internal clock or a compare enable signal transmitted to the re-synchronizer.

10. The tester in accordance with claim 3, further comprising a fetch clock round trip delay compensator for compensating for a round trip delay of the data strobe enable signal, an internal clock or a compare enable signal transmitted to the re-synchronizer.

11. The tester in accordance with claim 7, further comprising a fetch clock round trip delay compensator for compensating for the round trip delay of the data strobe enable signal, the internal clock or the compare enable signal transmitted to the re-synchronizer.

12. The tester in accordance with claim 1, further comprising a reference clock selector for selecting the fetch reference clock from the data strobe signal or the internal clock of the tester, and
wherein the data fetcher fetches the output data from the DUT based on the fetch reference clock selected by the reference clock selector.

13. The tester in accordance with claim 12, wherein the pattern generator generates a data strobe enable signal to be transmitted to the data fetcher, the data strobe enable signal enabling the data strobe signal, and the reference clock selector selects the fetch reference clock from a signal having a postamble removed thereof and the internal clock based on the data strobe enable signal.

14. The tester in accordance with claim 13, further comprising a fetch clock round trip delay compensator for compensating for a round trip delay of the data strobe enable signal or the internal clock.
